(19) United States
(12) Patent Application Publication
(10) Pub. No.: US 2002/0076986 A1
(43) Pub. Date: Jun. 20, 2002

(54) Enhanced card edge connector

(76) Inventors: William Hugh Cochran, Rochester, MN (US); William Paul Hovis, Rochester, MN (US); Mark David Plucinski, Rochester, MN (US); Glenn Wood Sellers JR., Rochester, MN (US)

Correspondence Address: RABIN & CHAMPAGNE, PC, 1101 14TH STREET, NW, SUITE 500, WASHINGTON, DC, 20005, US

(21) Appl. No.: 09/735,895

(22) Filed: Dec. 14, 2000

(51) Int. Cl. H01R 24/00

(52) U.S. Cl. 439/637

(57) ABSTRACT

An electrical connector includes a housing having a slot formed therein. The electrical connector further includes a plurality of conductive contact bands disposed within the slot. Each of the contact bands has a surface with a roughness defined by a plurality of microscopic irregularities. Each of the contact bands additionally has a plurality of projections, each of which projects above the surface of the contact band by a distance equal to a value between about 0.1% and 99% of a width of the contact band. The projections of each contact band electrically engage, at a plurality of different locations, with a conductive member insertable into the slot.

### BACKGROUND OF THE INVENTION

1. Field of the Invention

The invention relates to an enhanced electrical connector, such as a card edge connector used to electrically couple and join two printed circuit boards in an angular arrangement.

2. Background Information

Computer systems typically include a number of printed circuit boards that are directly electrically coupled together. One typical arrangement includes providing a first printed circuit board with an electrical connector, such as a card edge connector, on a surface thereof. The card edge connector is electrically coupled to associated electrical circuitry of the first printed circuit board in a known manner. For example, the card edge connector may have a number of pins located on a lower edge thereof, each of which projects into a respective through hole formed in the first printed circuit board. Each of the pins may then be soldered to the associated electrical circuitry.

Typically, the card edge connector has a slot in which an edge of a second printed circuit board may be inserted. Using this arrangement, the two boards are disposed in a perpendicular or other angular relationship when “mated” together.

Moreover, the card edge connector typically has a number of flexible, resilient conductive contact bands disposed on opposing sides of the slot. The contact bands conventionally have an elongated configuration, and are arranged to extend from a top of the slot to a bottom of the slot for connection to the respective pins. Further, an intermediate portion of each contact band is tailored to project into the slot, so that a distance between the respective contact bands disposed on opposite sides of the slot is less than a thickness of the second printed circuit board. This configuration allows the contact bands to exert a substantial force (known as a “mating force” or a “normal force”) against the respective surfaces of the second printed circuit board, for example, when the edge of the second printed circuit board is inserted into the slot.

Moreover, the second printed circuit board will typically be provided with a number of contact pads along its edge. The contact pads engage with the respective contact bands, when the second printed circuit board is inserted into the slot.

In order to reduce the impedance and prevent corrosion of the various contacting components, the contact pads and the contact bands may be plated, for example, with gold, tin-lead or other materials. The contact pads and contact bands need not be plated with the same material. Nevertheless, the surfaces of the contact bands and the contact pads are still subject to the problem of oxidation, and to the accumulation of dirt and debris. The oxidation, dirt and/or debris may prevent an adequate electrical connection from being established between the contact bands and the contact pads.

Furthermore, it is conventional to form the contact bands with a relatively smooth contact surface. This is believed to be desirable, so as to minimize the force required to insert the edge of the second printed circuit board into the slot, as well as to minimize wear of the contacting surfaces during the insertion process.

However, with this known configuration, when the second printed circuit board is inserted into the slot of the card edge connector, the contact bands' relatively smooth contact surface simply slides over the oxidation, dirt and debris without significant removal thereof. Thus, the impedance between the contact bands and the associated contact pads may be disadvantageously high.

Moreover, the conventional contact bands typically have only one, relatively large point of contact each. That is, since the contact bands are made to be as smooth as economically feasible, the contact surface of each contact band will engage the respective contact pad at only one location.

However, and as is well known, the degree of electrical contact between the contact bands and the associated contact pads relies, at least on part, on the mating force that is exerted by the contact bands against the contact pads, as well as on a size of the point of contact. That is, with a large point of contact, the mating force will be distributed over a larger area than with a small point of contact. Thus, a contact band having a large point of contact with a contact pad may have the mating force distributed over too large an area to provide an adequate electrical connection. Moreover, such a contact band will be less likely to remove any oxidation or debris from the respective contacting surfaces during the insertion process, than a contact band having a smaller point of contact, but similar mating force.

While it is known to increase a mating force by using thicker, more robust contact bands, the contact bands of the conventional card edge connector are typically relatively small, both in thickness and in width. This renders the contact bands very flexible and deformable, and may prevent the contact bands from exerting a sufficient mating force when there is a large point of contact. Thus, the contact bands of the conventional card edge connector may not provide for a secure electrical connection.

### SUMMARY OF THE INVENTION

It is, therefore, a principle object of this invention to provide an enhanced card edge connector.

It is another object of the invention to provide an enhanced card edge connector that solves the above mentioned problems.

These and other objects of the present invention are accomplished by the enhanced card edge connector disclosed herein.

In an exemplary aspect of the invention, an electrical connector, such as a card edge connector, includes a housing. The housing has a slot formed along one longitudinal upper edge. The slot is configured to receive an edge of a printed circuit board, in a manner which is well known to those skilled in the art.

Further, the electrical connector has a plurality of resilient, flexible conductive contact bands disposed therein, and which are accessible via the slot. A first set of conductive contact bands are disposed on one side of the slot, and a second set of conductive contact bands are disposed on the other side of the slot, so that respective surfaces of the contact bands on opposite sides of the slot face one another, with a space formed therebetween.

Further, the conductive contact bands typically project into the slot a predefined distance. When the edge of the printed circuit board is inserted into the slot, conductive members, such as contact pads disposed on the edge of the printed circuit board, will come into contact with the respective contact bands, thus electrically coupling the printed circuit board to the electrical connector.

In an exemplary aspect of the invention, the surfaces of the respective conductive contact bands are provided with a plurality of projections. Thus, unlike the conventional contact bands, which contact the respective contact pads at essentially only one contact point (i.e., point of contact) each, the present invention advantageously provides for multiple contact points per contact band, (i.e., at least one contact point per projection) which greatly improves the reliability of the electrical connector. For example, in an exemplary aspect of the present invention, the surface of the contact bands can be roughened to form either a uniform array or a random pattern. The roughening can be accomplished, for example, by etching the surface of the contact band, in any conventional manner, to provide for a number of the projections. Alternatively, the surface of the contact bands can be selectively plated, for example, by sputtering the surface with a conductive material, to provide for a number of the projections. Alternatively, since the contact bands are conventionally formed by performing a stamping operation, the stamping operation can also be used to simultaneously (or sequentially) form the projections into the surface of the contact bands by stamping the projections into the contact bands during the formation of the contact bands. Thus, the contact bands, according to the present invention, can be manufactured at little or no additional cost.

Preferably, the projections extend well beyond a surrounding area of the surface. That is, it is appreciated that a conventional contact band, on a microscopic level, will have some irregularities formed on its surface. However, these microscopic irregularities are too small to provide any appreciable cleaning of the respective contacting surfaces during the insertion process, or to serve as individual contact points. In contrast, the projections according to the present invention preferably project out beyond the surrounding surface of the contact band by an appreciable (macroscopic) amount. In an exemplary aspect of the present invention, the projections have a peak-to-valley height that is 0.1% to 99% of w, wherein w is a width of the contact band. Thus, should the contact bands have a width of about 1 millimeter, for example, the projections would have heights of about 0.001 to about 0.99 millimeters. However, the present invention is not to be limited to this particular aspect ratio, but can instead have projections that are either larger or smaller relative to the width of the contact band, without departing from the spirit and scope of the invention.

In further exemplary aspects of the invention, the projections can have a variety of configurations, and can be arranged in a variety of different manners. For example, the contact bands can have two or more elongated parallel ridges formed down a length thereof. Alternatively, the projections can be bumps arranged in either linear arrays or in a random manner. The bumps can be, for example, semi-circular in shape. However, whatever configuration or arrangement that is chosen, it is preferred that at least two projections be provided per contact band, so as to increase the number of contact points of the contact band over that which is provided using the conventional contact bands.

In a further exemplary aspect of the invention, it is also contemplated that the concept of the present invention can be applied to the contact pads on the edge of a circuit board. In this arrangement, due to the processing constraints involved in manufacturing the circuit board, it may not be possible to stamp out the contact pads with the projections formed thereon. Thus, this configuration would lend itself to the formation of the projections using either a sputtering or an etching technique. However, since this would require modification of the circuit board, which is a relatively expensive item, and since these techniques are more expensive and time-consuming than the aforementioned stamping technique, it is preferred that the projections be formed on the contact bands of the electrical connector, so that standard off-the-shelf printed circuit boards can be utilized without any modifications thereto.

### BRIEF DESCRIPTION OF THE DRAWINGS

FIG. 1 illustrates a card edge connector being utilized to join two printed circuit boards together, in accordance with an exemplary aspect of the present invention.

FIG. 2 is a top-down view of the card edge connector shown in FIG. 1.

FIG. 3 is a sectional view of the card edge connector shown in FIG. 2, taken along sectional line 3-3.

FIG. 4 is a side view of conventional contact bands of a card edge connector.

FIGS. 5 and 6 are side views of various exemplary aspects of contact bands of card edge connectors, in accordance with the present invention.

FIG. 7 is an elevational view of a portion of an exemplary aspect of a contact band of a card edge connector, in accordance with the present invention.

FIG. 8 is a sectional view of the contact band shown in FIG. 7, taken along section line 8-8.

FIG. 9 is an elevational view of a portion of an exemplary aspect of a contact band of a card edge connector, in accordance with the present invention.

FIG. 10 is a sectional view of the contact band shown in FIG. 9, taken along section line 10-10.

FIG. 11 is an elevational view of a portion of an exemplary aspect of a contact band of a card edge connector, in accordance with the present invention.

FIG. 12 is view of a card edge connector, manufactured in accordance with the present invention, being utilized in a computer system.

### DETAILED DESCRIPTION OF THE PREFERRED EMBODIMENTS

The invention will now be described in more detail by way of example with reference to the embodiments shown in the accompanying figures. It should be kept in mind that the following described embodiments are only presented by way of example and should not be construed as limiting the inventive concept to any particular physical configuration.

Further, if used and unless otherwise stated, the terms “upper”, “lower”, “front”, “back”, “over”, “under”, and similar such terms are not to be construed as limiting the invention to a particular orientation. Instead, these terms are used only on a relative basis.

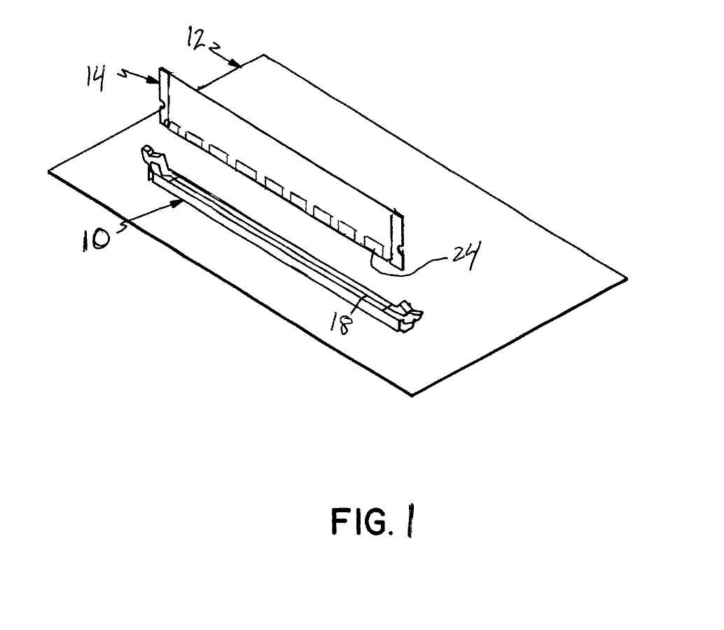

FIG. 1 illustrates an exemplary embodiment of the invention which includes an electrical connector 10. The electrical connector 10 is of a type conventionally utilized for electrically coupling and joining two printed circuit boards 12, 14 together in a perpendicular, or other angular relationship.

By way of example, the first printed circuit board 12 may be a motherboard, primary logic board, PCI (peripheral component interconnect) riser board or a memory riser board. The second printed circuit board 14 may be a PCI board, a DIMM (dual inline memory module) board or a RIMM (rambus inline memory module) board, SODIMM (small outline dual inline memory module) board, and other applications that use tabbed edge connector technology. However, the present invention is not limited to use with these particular types of boards. Instead, the present invention can be utilized with any printed circuit boards that are typically coupled together using an electrical connector.

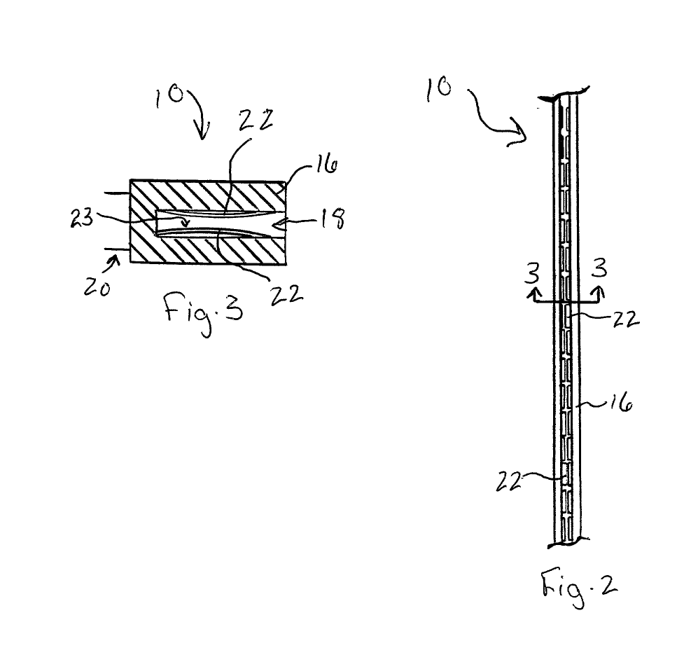

More particularly, and referring also to FIGS. 2 and 3, the electrical connector 10 may be a card edge connector, which includes a housing 16. The housing 16 may be formed from an insulative material, such as plastic. In the illustrated exemplary embodiment, the housing 16 has a generally elongated block shape. Further, the housing 16 has a slot 18 formed along its longitudinal upper edge. The slot 18 is configured to receive an edge of the second printed circuit board 14, in a manner which is well known to those skilled in the art.

Further, the card edge connector 10 may be provided with electrical terminals or pins 20 projecting from a lower longitudinal edge thereof. The pins 20 allow the card edge connector 10 to be electrically coupled to the first printed circuit board 12 in a conventional manner. For example, the pins 20 can be inserted into through holes (not shown) formed in the first printed circuit board 12, and soldered into place in such a manner so that the pins are coupled with the associated electrical circuitry (not shown) of the first printed circuit board. Of course, the card edge connector 10 can be coupled to the first printed circuit board 12 in other manners, without departing from the spirit of the invention.

Moreover, the card edge connector 10 has a plurality of resilient, flexible conductive contact bands 22 disposed therein, and which are accessible via the slot 18. As is conventional, the respective contact bands 22 are each coupled to a respective terminal or pin 20 of the electrical connector 10. Typically, a first set of conductive contact bands 22 are disposed on one side of the slot 18, and a second set of conductive contact bands are disposed on the other side of the slot, so that respective surfaces 23 of the contact bands on opposite sides of the slot face one another, with a space formed therebetween.

Moreover, typically the contact bands 22 are disposed within the slot 18 at a relatively high density. For example, in an exemplary aspect of the invention, the density is about twenty to forty or more contact bands 22 per inch (i.e., ten to twenty or more per inch on each side of the slot).

Further, the conductive contact bands 22 typically project into the slot a predefined distance. When the edge of the second printed circuit board 14 is inserted into the slot 18, conductive members 24 (see FIG. 1), such as contact pads disposed on the edge of the second printed circuit board, will come into contact with the respective contact bands 22, thus electrically coupling the second printed circuit board to the first printed circuit board 12.

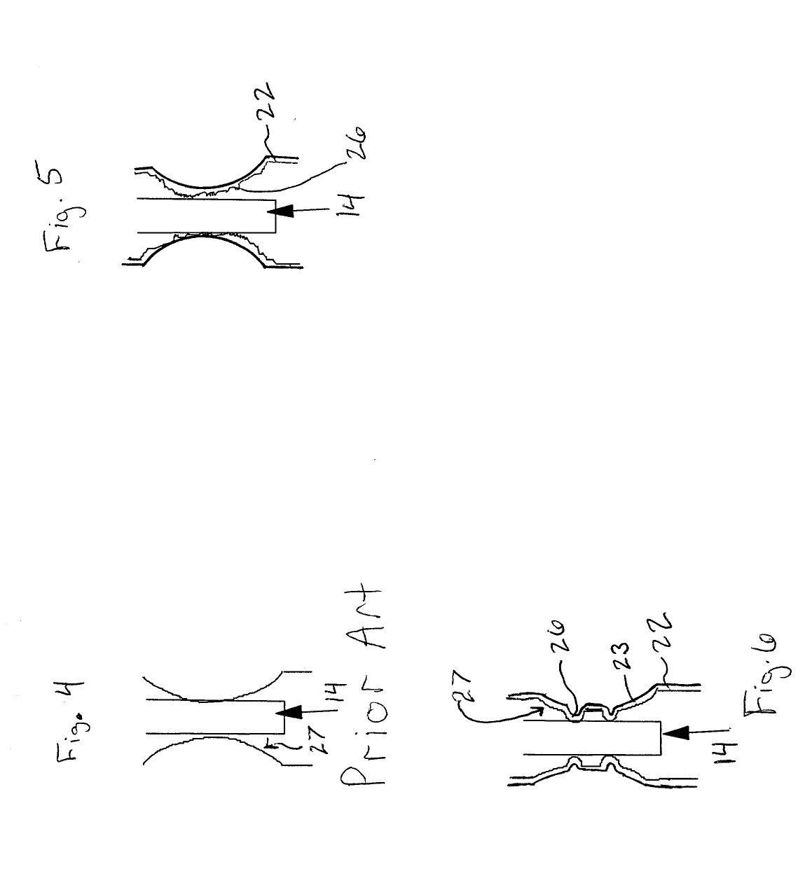

Referring also to FIGS. 4-6, the surfaces 23 of the respective conductive contact bands 22 are provided with a plurality of projecting members, such as projections 26. Thus, unlike the conventional contact bands, such as shown in FIG. 4, which contact the respective contact pads at essentially only one contact point each, the present invention provides for multiple contact points per contact band 22, (i.e., at least one contact point per projection 26) which greatly improves the reliability of the card edge connector. For example, in one exemplary aspect of the present invention, the surface 23 of the contact bands 22 can be roughened to form either a uniform array or a random pattern. The roughening can be accomplished, for example, by etching the surface 23 of the contact band 22, in any conventional manner, to provide for a number of the projections 26. Alternatively, the surface 23 of the contact bands 22 can be selectively plated, for example, by sputtering the surface with a conductive material, to provide for a number of the projections 26. Further, the projections 26 can be grown, or formed using chemical deposition. Alternatively, since the contact bands 22 are conventionally formed by performing a stamping operation, the stamping operation can be used to simultaneously form the projections 26 into the surface 23 of the contact bands by stamping the projections into the contact bands during the formation of the contact bands. Thus, the contact bands 22, according to the present invention, can be manufactured at little or no additional cost.

Preferably, the projections 26 extend well beyond a surrounding area of the surface 23. That is, and as shown best in FIGS. 4 and 6, it is appreciated that any contact band, on a microscopic level, will inherently have some irregularities 27 formed on its surface. However, these microscopic irregularities 27, typically in the range of 0.01 to 0.1 microns, are too small to provide any appreciable cleaning of the respective contacting surfaces, or to serve as individual contact points. However, the projections 26 according to the present invention preferably project out beyond the surrounding surface of the contact band 22 by an appreciable (macroscopic, for example) amount. In an exemplary aspect of the present invention, the projections 26 have a peak-to-valley height that is 0.1% to 99% of w, wherein w is a width of the contact band 22 (see FIG. 7). Thus, should the contact bands 22 have a width of about 1 millimeter, for example, the projections 26 would have heights of about 0.001 to about 0.99 millimeters. However, the present invention is not to be limited to this particular aspect ratio, but can instead have projections 26 that are either larger or smaller relative to the width of the contact band, without departing from the spirit and scope of the invention.

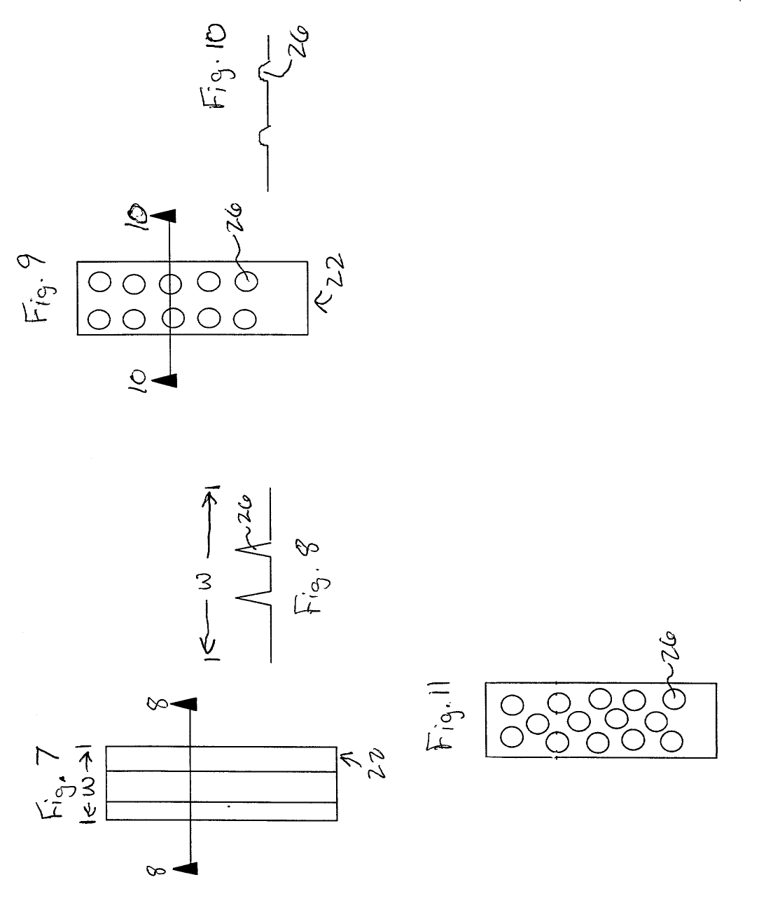

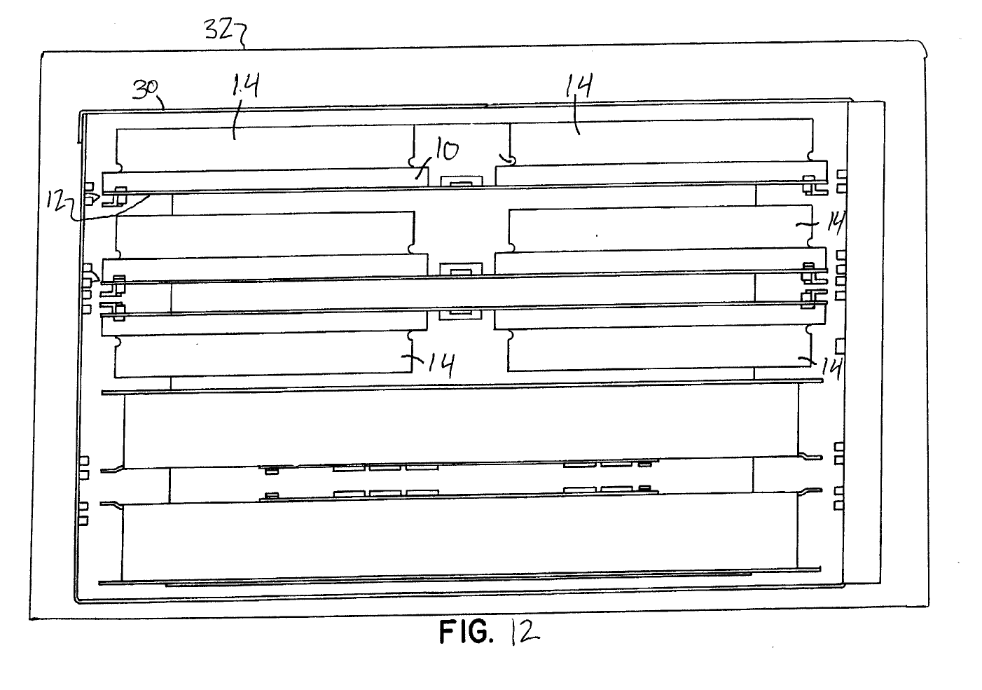

As shown in FIGS. 7-11, the projections 26 can have a variety of configurations, and can be arranged in a variety of different manners. For example, as shown in FIGS. 7 and 8, the contact bands 22 can have two or more elongated parallel ridges formed down a length thereof. Alternatively, as shown in FIGS. 9-11, the projections 26 can be bumps arranged in either linear arrays or in a random manner. The bumps can be any of a variety of shapes. In the exemplary embodiment, the bumps are, for example, semi-circular in shape. However, whatever configuration or arrangement that is chosen, it is preferred that at least two projections 26 be provided per contact band 22, so as to increase the number of contact points of the contact band over that which is provided using the conventional contact bands.

Although the exemplary embodiment of the invention has been described in connection with its application on a contact band 22 of an electrical connector 10, it is also contemplated that the concept of the present invention can be applied to the contact pads 24 on the edge of the circuit board 14. In this arrangement (not shown), due to the processing constraints involved in manufacturing the circuit board, it may not be possible to stamp out the contact pads with the projections formed thereon. Thus, this configuration would lend itself to the formation of the projections using either a sputtering or an etching technique. However, since this would require modification of the circuit board, which is a relatively expensive item, and since these techniques are more expensive and time-consuming than the aforementioned stamping technique, it is preferred that the projections be formed on the contact bands of the electrical connector, so that standard off-the-shelf printed circuit boards can be utilized without any modifications thereto.

Referring to FIG. 12, the card edge connector 10 is shown, according to the present invention, being utilized to connect a DIMM board 14 to a further printed circuit board 12, for example, a memory riser card. The various printed circuit boards are disposed within a central electronics complex 30, which is then disposed within a housing 32 of a computer.

It should be understood, however, that the invention is not necessarily limited to the specific arrangement and components shown and described above, but may be susceptible to numerous variations within the scope of the invention.

It will be apparent to one skilled in the art that the manner of making and using the claimed invention has been adequately disclosed in the above-written description of the preferred embodiments taken together with the drawings.

It will be understood that the above description of the preferred embodiments of the present invention are susceptible to various modifications, changes, and adaptations, and the same are intended to be comprehended within the meaning and range of equivalents of the appended claims.

What is claimed is:

1. An electrical connector, comprising:
a housing having a slot formed therein; and
a plurality of conductive contact bands disposed within said slot, each of said contact bands having a surface with a roughness defined by a plurality of microscopic irregularities, each of said contact bands further having a plurality of projections each of which projects above the surface of the contact band by a distance equal to a value between about 0.1% and 99% of a width of said contact band, said projections of each contact band being electrically engageable, at a plurality of different locations, with a conductive member insertable into the slot.

2. The electrical connector according to claim 1, wherein said electrical connector is a card edge connector.

3. The electrical connector according to claim 1, wherein said plurality of contact bands includes a first set of contact bands arranged on one side of the slot, and a second set of contact bands arranged on an opposite side of the slot, each of said projections of said contact bands of the first set projecting toward the contact bands of the second set, and each of said projections of said contact bands of the second set projecting toward the contact bands of the first set.

4. The electrical connector according to claim 3, wherein the contact bands of the first set are arranged at a density greater than about ten contact bands per inch, and the contact bands of the second set are arranged at a density greater than about ten contact bands per inch,

5. The electrical connector according to claim 4, wherein the contact bands of the first set are arranged at a density equal to or greater than about twenty contact bands per inch, and the contact bands of the second set are arranged at a density equal to or greater than about twenty contact bands per inch.

6. The electrical connector according to claim 1, wherein the width of each said contact band is defined by a distance across the surface of the respective contact band and between two opposing longitudinal edges of the respective contact band; and wherein each said projection projects above the surface by a distance equal to a value between about 10% and about 90% of the width.

7. The electrical connector according to claim 1, wherein said projections are arranged in a random pattern.

8. The electrical connector according to claim 1, wherein said projections are arranged in an array.

9. The electrical connector according to claim 1, wherein said projections comprise a plurality of projecting bumps.

10. The electrical connector according to claim 9, wherein said bumps are semi-circular in shape.

11. The electrical connector according to claim 9, wherein said bumps are stamped into said respective contact bands.

12. The electrical connector according to claim 1, wherein said projections comprise a plurality of projecting ridges.

13. The electrical connector according to claim 1, wherein said projections comprise at least two projecting, elongated ridges.

14. The electrical connector according to claim 13, wherein said ridges are stamped into said respective contact bands.

15. A printed circuit board arrangement, comprising:
a first printed circuit board;
a card edge connector disposed on said first printed circuit board, said card edge connector having a housing with a slot formed therein, and having a plurality of conductive bands disposed within the slot, each of said conductive bands being in electrical communication with circuitry of said first printed circuit board; and
a second printed circuit board having a plurality of conductive contact pads disposed along an edge thereof, the edge being insertable within the slot so that the contact pads engage with respective conductive bands so as to electrically couple the first printed circuit board to the second printed circuit board, wherein each contact pad engages with a respective one conductive band at a plurality of different contact points.

16. The printed circuit board arrangement according to claim 15, wherein said plurality of contact bands includes a first set of contact bands arranged on one side of the slot, and a second set of contact bands arranged on an opposite side of the slot, each of said contact bands of the first set having a surface facing the contact bands of the second set, and each of said contact bands of the second set having a surface facing the contact bands of the first set.

17. The printed circuit board arrangement according to claim 16, wherein each of the surfaces has a plurality of projecting members arranged in a random pattern for the electrical engagement of each respective contact pad to each respective conductive band at the plurality of different contact points.

18. The printed circuit board arrangement according to claim 16, wherein each of the surfaces has a plurality of projecting members arranged in an array for the electrical engagement of each respective contact pad to each respective conductive band at the plurality of different contact points.

19. The printed circuit board arrangement according to claim 16, wherein each of the surfaces has a plurality of projecting bumps for the electrical engagement of each respective contact pad to each respective conductive band at the plurality of different contact points.

20. The printed circuit board arrangement according to claim 19, wherein said bumps are semi-circular in shape.

21. The printed circuit board arrangement according to claim 19, wherein said bumps are stamped into said respective contact bands.

22. The printed circuit board arrangement according to claim 16, wherein each of the surfaces has a plurality of projecting ridges for the electrical engagement of each respective contact pad to each respective conductive band at the plurality of different contact points.

23. The printed circuit board arrangement according to claim 16, wherein each of the surfaces has at least two projecting, elongated ridges thereon for the electrical engagement of each respective contact pad to each respective conductive band at the plurality of different contact points.

24. The printed circuit board arrangement according to claim 23, wherein said ridges are stamped into said respective contact bands.

25. A method of improving an electrical connection between two printed circuit boards, comprising:
providing an electrical connector having a plurality of conductive bands;
providing a first printed circuit board having a plurality of contact pads formed thereon;
providing a plurality of macroscopic projections on a surface of said contact pads or said conductive bands;
attaching the electrical connector to a second printed circuit board; and
electrically coupling each respective conductive band, at a plurality of different contact points defined by the macroscopic projections, to a respective contact pad, so as to electrically couple the first printed circuit board to the second printed circuit board.

26. The method according to claim 25, wherein the electrical connector comprises a card edge connector.

27. The method according to claim 26, wherein the card edge connector includes a housing with a slot formed therein, wherein said plurality of contact bands includes a first set of contact bands arranged within the slot and on one side of the slot, and a second set of contact bands arranged within and on an opposite side of the slot, each of said contact bands of the first set having a surface facing the contact bands of the second set, and each of said contact bands of the second set having a surface facing the contact bands of the first set.

28. The method according to claim 27, wherein said macroscopic projections are disposed on the respective surfaces of the contact bands.

29. The method according to claim 28, wherein the plurality of macroscopic projections are formed on the surface of each contact band in a random pattern.

30. The method according to claim 28, wherein the plurality of macroscopic projections are formed on the surface of each contact band in an array.

31. The method according to claim 28, wherein the plurality of macroscopic projections are formed by stamping.

32. The method according to claim 31, wherein said stamping simultaneously forms the contact bands and the macroscopic projections.

33. The method according to claim 28, wherein the plurality of macroscopic projections are formed by one of sputtering, growing, chemical deposition, and plating the macroscopic projections onto the surface of the respective contact bands.

34. The method according to claim 28, wherein the plurality of macroscopic projections are formed by etching the surfaces of the respective contact bands.

35. A computer system, comprising:
a computer housing; and
a printed circuit board arrangement disposed within said housing, said arrangement comprising:
a first printed circuit board;
a card edge connector disposed on said first printed circuit board, said card edge connector having a housing with a slot formed therein, and having a plurality of conductive bands disposed within the slot, each of said conductive bands being in electrical communication with circuitry of said first printed circuit board; and
a second printed circuit board having a plurality of conductive contact pads disposed along an edge thereof, the edge being insertable within the slot so that the contact pads engage with respective conductive bands to electrically couple the first printed circuit board to the second printed circuit board, wherein each contact pad engages with a respective one conductive band at a plurality of different contact points.

36. The computer system according to claim 35, wherein said plurality of contact bands includes a first set of contact bands arranged on one side of the slot, and a second set of contact bands arranged on an opposite side of the slot, each of said contact bands of the first set having a surface facing the contact bands of the second set, and each of said contact bands of the second set having a surface facing the contact bands of the first set.

37. The computer system according to claim 36, wherein each of the surfaces has a plurality of projecting members arranged in a random pattern for the electrical engagement of each respective contact pad to each respective conductive band at the plurality of different contact points.

38. The computer system according to claim 36, wherein each of the surfaces has a plurality of projecting members arranged in an array for the electrical engagement of each respective contact pad to each respective conductive band at the plurality of different contact points.

39. The computer system according to claim 36, wherein each of the surfaces has a plurality of projecting bumps for the electrical engagement of each respective contact pad to each respective conductive band at the plurality of different contact points.

40. The computer system according to claim 39, wherein said bumps are semi-circular in shape.

41. The computer system according to claim 39, wherein said bumps are stamped into said respective contact bands.

42. The computer system according to claim 36, wherein each of the surfaces has a plurality of projecting ridges for the electrical engagement of each respective contact pad to each respective conductive band at the plurality of different contact points.

43. The computer system according to claim 36, wherein each of the surfaces has at least two projecting, elongated ridges thereon for the electrical engagement of each respective contact pad to each respective conductive band at the plurality of different contact points.

44. The computer system according to claim 43, wherein said ridges are stamped into said respective contact bands.
